(19) United States
(12) Patent Application Publication
(10) Pub. No.: US 2025/0204576 A1
(43) Pub. Date: Jun. 26, 2025

(54) AEROSOL GENERATING ARTICLE AND AEROSOL GENERATING SYSTEM

(71) Applicant: KT&G Corporation, Daejeon (KR)

(72) Inventors: Ick Joong KIM, Daejeon (KR); Sung Jong KI, Daejeon (KR); In Su PARK, Daejeon (KR); Kyung Bin JUNG, Daejeon (KR)

(21) Appl. No.: 18/889,048

(22) Filed: Sep. 18, 2024

(30) Foreign Application Priority Data
Dec. 21, 2023 (KR) 10-2023-0188514

(51) Int. Cl. A24B 15/28; H05B 6/80

(52) U.S. Cl. CPC A24B 15/283; H05B 6/80

(57) ABSTRACT

An aerosol generating article includes an aerosol generating material that is heated by being exposed to microwaves, and a first capsule that is crushed by being exposed to the microwaves, wherein the first capsule incudes a first core including a first material and a first shell surrounding the first core, and the first shell includes a first microwave-responsive material.

### CROSS-REFERENCE TO RELATED APPLICATION

This application is based on and claims priority under 35 U.S.C. § 119 to Korean Patent Application No. 10-2023-0188514, filed on Dec. 21, 2023, in the Korean Intellectual Property Office, the disclosure of which is incorporated by reference herein in its entirety.

### BACKGROUND

### 1. Field

Embodiments relate to an aerosol generating article and an aerosol generating system that may generate an aerosol by being heated by a dielectric heating method.

### 2. Description of the Related Art

Recently, there has been an increasing demand for an alternative method of overcoming disadvantages of general cigarettes. For example, there has been an increasing demand for a system that generates an aerosol by heating a cigarette (or “an aerosol generating article”) by using an aerosol generating device, other than a method of generating an aerosol by burning the cigarette.

In the aerosol generating system of the related art, a heating element using an electrical resistance heating method or an induction heating method heats an aerosol generating article by surrounding the outside of the aerosol generating article or by being inserted into the aerosol generating article.

### SUMMARY

In the aerosol generating system of the related art, a region of an aerosol generating article, which is close to a heating element, may be heated to a relatively high temperature, and a region of the aerosol generating article, which is far from the heating element, may be heated to a relatively low temperature. Because an aerosol generating article is heated unevenly, active ingredients (for example, nicotine and/or an aerosol generating material) in a region heated to a relatively low temperature may not be fully transferred and remain in the aerosol generating article. Also, the amount of active ingredients transferred to a user is not constant throughout the entire heating period, and a taste of smoke may not be constant.

Also, in the general aerosol generating system of the related art, an aerosol generating article is heated through heat conduction from a heating element, and accordingly, a certain preheating time may be required to heat the aerosol generating article. Also, an aerosol generated at the beginning of a heating period when the temperature of an aerosol generating article does not increase sufficiently may not include sufficient active ingredients.

In addition, a flavoring material that adds flavor to an aerosol has high volatility, and accordingly, a capsule is used to prevent the flavoring material from being lost. In general, a capsule includes a core that includes a flavoring material and a shell surrounding the core. The capsule is embedded in the aerosol generating article, and when used, a user presses a portion in which the capsule is embedded to crush the capsule. When the capsule is crushed, the flavoring material may be released to add flavor to an aerosol. However, a user may have difficulty in crushing a capsule depending on the thickness, strength, softness, viscosity, and so on of a shell.

Objects to be achieved by embodiments of the disclosure are not limited to the objects described above, and objects not described may be clearly understood by a person of skill in the art to which the embodiments belong from the present specification and the attached drawings.

Additional aspects will be set forth in part in the description which follows and, in part, will be apparent from the description, or may be learned by practice of the presented embodiments of the disclosure.

According to an embodiment, an aerosol generating article includes an aerosol generating material that is heated by being exposed to microwaves, and a first capsule that is crushed by being exposed to the microwaves, wherein the first capsule incudes a first core including a first material and a first shell surrounding the first core, and the first shell includes a first microwave-responsive material.

According to another embodiment, an aerosol generating system includes an aerosol generating article and an aerosol generating device configured to accommodate the aerosol generating article, wherein the aerosol generating device includes a heater assembly configured to generate microwaves for heating the aerosol generating article.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic view of an aerosol generating article according to an embodiment;

FIG. 2 is a schematic view of an aerosol generating article according to another embodiment;

FIG. 3 is a schematic view of an aerosol generating article according to another embodiment;

FIG. 4 is a perspective view of an aerosol generating device according to an embodiment;

FIG. 5 is an internal block diagram of an aerosol generating device according to an embodiment;

FIG. 6 is an internal block diagram of a dielectric heater of FIG. 5;

FIG. 7 is a perspective view of a heater assembly according to an embodiment;

FIG. 8 is a cross-sectional view of the heater assembly of FIG. 7; and

FIG. 9 is a perspective view schematically illustrating a heater assembly according to another embodiment.

### DETAILED DESCRIPTION

Hereinafter, embodiments of the disclosure are described in detail with reference to the attached drawings, and regardless of the drawing symbols, identical or similar components are given the same reference numerals, and redundant descriptions thereof are omitted.

Suffixes “module”, “unit”, and “portion” used for components in the following description are given or used interchangeably only for the sake of convenience of describing the disclosure and do not have distinct meanings or functions in themselves.

Also, in describing the embodiments disclosed in the disclosure, when it is determined that detailed descriptions of the related known technologies may obscure the gist of the embodiments disclosed in the disclosure, the detailed descriptions are omitted. Also, the attached drawings are only for easy understanding of the embodiments disclosed in the disclosure, and the technical idea disclosed in the disclosure is not limited by the attached drawings and should be understood to include all changes, equivalents, and substitutes included in the idea and technical scope of the disclosure.

Terms including ordinal numbers, such as “first”, “second”, and so on, may be used to describe various components, but the components are not limited by the terms. The terms described above are used only for the purpose of distinguishing one component from another component.

When a component is described to be “connected” or “coupled” to another component, it should be understood that the component may be directly connected or coupled to another component and may be connected or coupled thereto with other components therebetween. In addition, when it is described that a component is “directly connected” or “directly coupled” to another component, it should be understood that there are no other components therebetween.

Singular expressions include plural expressions unless the context clearly dictates otherwise.

As described herein, when an expression, such as “at least one” precedes arranged elements, the expression modifies all of the arranged elements rather than each of the arranged elements. For example, an expression “at least one of a, b, and c” should be interpreted to include a, b, c, a and b, a and c, b and c, or a and b and c.

Throughout the specification, an “aerosol generating device” may be a device that generates an aerosol by using an aerosol generating material to generate an aerosol that is directly inhalable into a user's lungs through the user's mouth.

Throughout the specification, an “aerosol generating article” means an article used in smoking. For example, an aerosol generating article may be a combustible cigarette used in a manner that is ignited and combusted, or may be a heating-type cigarette used in a manner that is heated by an aerosol generating device.

Throughout the specification, an “aerosol generating system” may include an aerosol generating device and an aerosol generating article. For example, an aerosol generating system may be a system that heats an aerosol generating article by using an aerosol generating device and transfers the generated aerosol to a user.

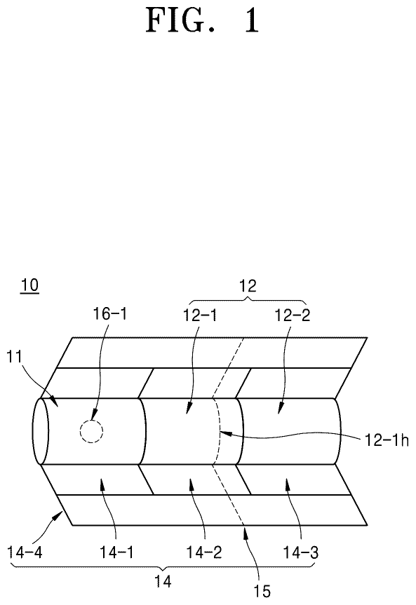

Throughout the specification, a “puff” means inhalation of a user. Inhalation may mean drawing an aerosol into a user's mouth, nose, or lungs through the user's mouth or nose. FIG. 1 is a schematic view of an aerosol generating article according to an embodiment.

Referring to FIG. 1, an aerosol generating article 10 may include an aerosol generating rod 11 and a filter rod 12. The filter rod 12 may be arranged downstream from the aerosol generating rod 11.

“Upstream” and “downstream” may be determined based on a direction in which air flows when a user inhales an aerosol by using the aerosol generating article 10. For example, when a user inhales an aerosol by using the aerosol generating article 10 illustrated in FIG. 1, air moves from the aerosol generating rod 11 toward the filter rod 12, and accordingly, the aerosol generating rod 11 is placed upstream from the filter rod 12. In addition, a person skilled in the art will easily understand that “upstream” and “downstream” may be relative depending on relationships between components.

The aerosol generating rod 11 may include a tobacco material. The aerosol generating rod 11 may be heated to generate an aerosol containing nicotine. The tobacco material may be in the form of a tobacco strand, a tobacco particle, a tobacco sheet, a tobacco bead, a tobacco granule, tobacco powder, or tobacco extract but is not limited thereto.

For example, the aerosol generating rod 11 may include a plurality of tobacco strands, and the plurality of tobacco strands may include cut tobacco sheets. The cut tobacco sheets may be obtained by cutting tobacco sheets. The cut tobacco sheets may be made by the following process. Tobacco raw materials are pulverized to make a slurry in which an aerosol generating material (for example, glycerin, propylene glycol, or so on), a flavoring liquid, a binder (for example, guar gum, xanthan gum, carboxymethyl cellulose, or so on), water, and so on are mixed. The slurry may include natural pulp or cellulose, and one or more binders may be mixed to be used as the slurry. The slurry may be cast to form a sheet, and then dried to make a tobacco sheet. The tobacco sheet may be cut, crimped, or shredded to make a cut tobacco sheet. The tobacco raw material may be tobacco leaves, tobacco stems, and/or tobacco fines generated during tobacco processing. In addition, other additives, such as wood cellulose fibers, may also be included in the tobacco sheet.

In addition, the aerosol generating rod 11 may include tobacco cut sheets made by mixing and processing various types of tobacco leaves, and then cutting the tobacco leaves. In addition, the aerosol generating rod 11 may include a mixture of cut tobacco sheets and tobacco cut sheets.

In another example, the aerosol generating rod 11 may include a plurality of tobacco granules. The tobacco granules may be particles each having a diameter of about 100 μm to about 2,000 μm. The plurality of tobacco granules may be manufactured by extruding a mixture of tobacco leaf powder, a pH adjuster, and a solvent.

The plurality of tobacco granules may be between filter materials. The filter materials may each include, for example, a fiber bundle of cellulose acetate fiber strands. The plurality of tobacco granules may be in a uniformly dispersed form between a plurality of cellulose fibers. In another example, the filter material may include a crimped paper sheet. The crimped paper sheet may be inside the aerosol generating rod 11 in a wound state. The crimped paper sheet may be wound around an axis extending in the longitudinal direction of the aerosol generating rod 11. The plurality of tobacco granules may be dispersed inside the wound paper sheet.

The tobacco material may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol but is not limited thereto. Also, the tobacco material may also include another additive, such as a flavoring agent, a humectant, and/or organic acid. Also, a flavoring liquid, such as menthol or a humectant, may be added to the tobacco material by being sprayed onto the tobacco material.

The aerosol generating rod 11 may also include other plant materials than the tobacco material. For example, the aerosol generating rod 11 may include an herbal material. The aerosol generating rod 11 may also include a sheet including the herbal material. The herbal material may include at least one of mint, lemongrass, cinnamon, a clover leaf, a rose petal, and corn silk but is not limited thereto. An aerosol generating material may be impregnated into the sheet including the herbal material.

Also, the aerosol generating rod 11 may include an aerosol generating substrate impregnated with a liquid aerosol generating composition. The aerosol generating substrate may include a crimped sheet, and the liquid aerosol generating composition may be included in the aerosol generating rod 11 in a state of being impregnated in the crimped sheet. Also, other additives, such as flavoring agents, humectants, and/or organic acids, and a flavoring liquid may be included in the aerosol generating rod 11 in a state in which the flavoring liquid is absorbed in the crimped sheet.

The aerosol generating substrate may be arranged inside the aerosol generating rod 11 in a wound state. The wound aerosol generating substrate may be wound around an axis extending in the longitudinal direction of the aerosol generating article 10, but is not limited thereto.

The crimped sheet may be a sheet formed of a polymer material. For example, the polymer material may include at least one of paper, cellulose acetate, lyocell, and polylactic acid. For example, the crimped sheet may be a paper sheet that does not generate an off-flavor due to heat, even when the crimped sheet is heated to a high temperature.

The liquid aerosol generating composition may include nicotine. The nicotine may include freebase nicotine and/or nicotine salt. The freebase nicotine may mean neutral nicotine that has not been protonated. For example, when a strong base, such as ammonia, is added to a positively charged nicotine salt, the strong base is converted into a cation, and the nicotine salt may become freebase nicotine, which is in a neutral state.

In addition, the liquid aerosol generating composition may include an aerosol generating material. The above description on the aerosol generating material may be equally applied to the aerosol generating material included in a tobacco material.

The liquid aerosol generating composition may be impregnated into the aerosol generating substrate in a ratio of about 0.05 g to about 1.0 g per 1 g of the aerosol generating material. For example, the liquid aerosol generating composition may be impregnated into the aerosol generating substrate in a ratio of about 0.1 g to about 0.8 g per 1 g of the aerosol generating material.

An aerosol generating material included in the aerosol generating rod 11 may be heated by being exposed to microwaves. Here, the aerosol generating material may function as a dielectric. Electric charges of the dielectric may vibrate or rotate due to microwave resonance, and the dielectric is heated due to frictional heat generated while the electric charges vibrate or rotate, and thus, the aerosol generating rod 11 may be heated.

The aerosol generating rod 11 may include a first capsule 16-1. For example, the aerosol generating rod 11 may include a plurality of tobacco strands, and the first capsule 16-1 may be surrounded by the plurality of tobacco strands. In another example, the aerosol generating rod 11 may include a crimped sheet impregnated with a liquid aerosol generating composition, and the first capsule 16-1 may be surrounded by the crimped sheet.

The first capsule 16-1 may include a first core and a first shell surrounding the first core. The first core may include a first material. When the first shell is crushed, the first material included in the first core may be released from the first core.

The first material may include at least one selected from a group including a flavoring material, nicotine, caffeine, and cannabinoid.

The flavoring materials may add flavor to an aerosol generated by the aerosol generating article 10. The flavoring material may include a natural flavoring material and/or synthetic flavoring material. For example, the synthetic flavoring material may include at least one selected from a group including ester, alcohol, aldehyde, ketone, phenol, ether, lactone, hydrocarbon, a nitrogen-containing compound, a sulfur-containing compound, and acid.

Also, the natural flavoring material may include one or more oils selected from a group including, for example, star anise, basil, calamus, caraway, pepper, cascarilla, ginger, sage, clary sage, clove, coriander, eucalyptus, fennel, pimento, juniper, fenugreek, laurel, mace, almond, anise, artemisia, apricot, strawberry, fig, ylang ylang, wintergreen, plum, elder, chamomile, galanga, quince, guava, cranberry, prickly ash, sandalwood, chamomile, jasmine, ginseng, cinnamon, star fruit, cinnamon, spearmint, apple mint, peppermint, geranium, thyme, tansy, tangerine, tuberose, peppermint, passion fruit, vanilla, rose, coffee, cypress, pine, mango, beeswax, musk, maple, melon, peach, lavender, and rosemary.

The term “cannabinoid” refers to any one of a class of naturally occurring compounds found in some species of cannabis plant, Cannabis sativa, Cannabis indica, and Cannabis ruderalis. A Cannabinoid compound that occurs naturally in the cannabis plant includes cannabidiol (CBD) and tetrahydrocannabinol (THC). The term “cannabinoid” is used to describe both naturally occurring cannabinoids and synthetically produced cannabinoids.

The first core may include a lipophilic solvent in which the first material is mixed. For example, the lipophilic solvent may include triglyceride, medium chain triglyceride (for example, triglyceride of caprylic acid and capric acid), vegetable oil (for example, olive oil, sunflower oil, corn oil, peanut oil, grapeseed oil, wheat germ oil, or rapeseed oil), mineral oil, silicone oil or a mixture of the silicone oil with triglyceride, fatty acid (for example, polyunsaturated fatty acid, docosahexaenoic acid, or so on), fatty acid ester (for example, isopropyl myristic acid), sucrose fatty acid ester, liquid paraffin, squalene, and so on.

The first shell may include a first microwave-responsive material and a membrane material. The membrane material may include at least one of a water-soluble hydrocolloid, such as gelatin, agar, carrageenan, alginic acid, or pectin, a gum, such as gellan gum, a starch, such as potato starch, or corn starch, and a starch derivative, such as dextrin, maltodextrin, or cyclodextrin. Also, the membrane material may also include a cellulose derivative, such as hydroxypropyl methyl cellulose (HPMC), hydroxypropyl cellulose (HPC), methyl cellulose (MC), or carboxymethyl cellulose (CMC), polyvinyl alcohol, polyol, and so on.

The first capsule 16-1 may be crushed by being exposed to microwaves. The first shell may include a first microwave-responsive material to be crushed by being exposed to microwaves. The first microwave-responsive material may be heated by being exposed to microwaves, and thus, the first shell may be crushed. The first microwave-responsive material may function as a dielectric. Electric charges of the dielectric may vibrate or rotate according to microwave resonance, and the dielectric may be heated by frictional heat generated while the electric charges vibrate or rotate, and thus, the first shell may be crushed.

A general capsule may be crushed by the pressure applied by a user's finger. In contrast to this, the first capsule 16-1 may be crushed by microwaves generated by a heater assembly of an aerosol generating device to be described below, and accordingly, user intervention is not required to crush the first capsule 16-1.

The first microwave-responsive material may maintain an appropriate strength for causing the first shell to maintain a shape by being included in the first shell and may crush the first shell by being exposed to microwaves. For example, the first microwave-responsive material may include at least one selected from a group including glycerin, propylene glycol, ethylene glycol, dipropylene glycol, diethylene glycol, triethylene glycol, tetraethylene glycol, and oleyl alcohol but is not limited thereto.

The first shell may include the first microwave-responsive material with about 20 wt % to about 40 wt % of the total weight of the first shell. When the first shell includes the first microwave-responsive material with about 20 wt % or less of the total weight of the first shell, the first capsule 16-1 may not be crushed even when exposed to microwaves having a frequency of 2.4 GHz to 2.5 GHz. Also, when the first shell includes the first microwave-responsive material with about 40 wt % or more of the total weight of the first shell, suitability for manufacturing the capsule may be reduced. For example, the first shell may include the first microwave-responsive material with about 20 wt % to about 30 wt % or about 25 wt % to about 30 wt % of the total weight of the first shell.

### Example 1: Microwave-Responsive Material 20 wt %

A capsule was manufactured such that a shell of the manufactured capsules had compositions shown in Table 1 below. Glycerin was used as the microwave-responsive material.

After water at about 85° C. to about 100° C. is supplied to a membrane material manufacturing vessel, the membrane material was introduced, and the paddles in the membrane material manufacturing vessel were stirred at 90 rpm. Thereafter, a microwave-responsive material was introduced and defoamed to manufacture the membrane material composition. The defoaming was performed by a defoamer under vacuum conditions.

The manufactured membrane material composition and medium-chain triglyceride in which menthol was dissolved as a core material were introduced into a capsule manufacturing device. The introduced membrane material composition and core material were discharged through a nozzle in an initial form of a capsule, and the initial form of a capsule was cooled with cooling oil to manufacture the capsule.

TABLE 1

| Classification | | Content (weight %) |
|---|---|---|
| Membrane material | Gelatin | 25 |
| | Gellan gum | 20 |
| | Starch | 35 |

| | |
|---|---|
| Microwave-responsive material | 20 |

### Example 2: Microwave-Responsive Material 25 wt %

A capsule was manufactured in the same manner as in Example 1 except that the capsule was manufactured such that a shell of the manufactured capsule had a composition of Table 2 below.

TABLE 2

| Classification | | Content (weight %) |
|---|---|---|
| Membrane material | Agar | 40 |
| | Pectin | 30 |
| | Alginate | 5 |

| | |
|---|---|
| Microwave-responsive material | 25 |

### Example 3: Microwave-Responsive Material 30 wt %

A capsule was manufactured in the same manner as in Example 1 except that the capsule was manufactured such that a shell of the manufactured capsule had a composition of Table 3 below.

TABLE 3

| Classification | | Content (weight %) |
|---|---|---|
| Membrane material | Carrageenan | 20 |
| | Starch | 50 |

| | |
|---|---|
| Microwave-responsive material | 30 |

### Example 4: Microwave-Responsive Material 35 wt %

A capsule was manufactured in the same manner as in Example 1, except that the capsule was manufactured such that a shell of the manufactured capsule had a composition of Table 4 below.

TABLE 4

| Classification | | Content (weight %) |
|---|---|---|
| Membrane material | Gelatin | 30 |
| | Starch | 35 |

| | |
|---|---|
| Microwave-responsive material | 35 |

### Example 5: Microwave-Responsive Material 40 wt %

A capsule was manufactured in the same manner as in Example 1, except that the capsule was manufactured such that a shell of the manufactured capsule had a composition of Table 5 below.

TABLE 5

| Classification | | Content (wt %) |
|---|---|---|
| Membrane material | Agar | 30 |
| | Pectin | 25 |
| | Alginate | 5 |

| | |
|---|---|
| Microwave-responsive material | 40 |

### Comparative Example 1: Microwave-Responsive Material 11 wt %

A capsule was manufactured in the same manner as in Example 1, except that the capsule was manufactured such that a shell of the manufactured capsule had a composition of Table 6 below.

TABLE 6

| Classification | | Content (weight %) |
|---|---|---|
| Membrane material | Agar | 43 |
| | Pectin | 38 |
| | Alginate | 8 |

| | |
|---|---|
| Microwave-responsive material | 11 |

### Comparative Example 2: Microwave-Responsive Material 15 wt %

A capsule was manufactured in the same manner as in Example 1 except that the capsule was manufactured such that a shell of the manufactured capsule had a composition of Table 7 below.

TABLE 7

| Classification | | Content (weight %) |
|---|---|---|
| Membrane material | Agar | 42 |
| | Pectin | 36 |
| | Alginate | 7 |

| | |
|---|---|
| Microwave-responsive material | 15 |

### Comparative Example 3: Microwave-Responsive Material 45 wt %

A capsule was manufactured in the same manner as in Example 1 except that the capsule was manufactured such that a shell of the manufactured capsule had a composition of Table 8 below.

TABLE 8

| Classification | | Content (weight %) |
|---|---|---|
| Membrane material | Agar | 27 |
| | Pectin | 23 |
| | Alginate | 5 |

| | |
|---|---|
| Microwave-responsive material | 45 |

### Experimental Example: Capsule Quality Evaluation

Qualities of capsules were evaluated in Example 1 to Example 5 and Comparative Examples 1 to Comparative Example 3, and the evaluation results are shown in Table 9 below.

Suitability for manufacturing the capsules was evaluated based on the following criteria.
O: Capsule is easily manufactured and may maintain a shape
Δ: Capsule is not crushed and a shape of the capsule is deformed
X: Capsule is not easily manufactured or is crushed without maintaining a shape

Strengths of capsules were evaluated based on the following criteria.
O: When pressure is applied with a finger, they are easily crushed
Δ: When pressure is applied by a finger, the capsule is not crushed unless considerable force is applied
X: When pressure is applied by a finger, the capsule is not crushed unless force that causes pain is applied

Crushability of microwaves was evaluated based on the following criteria after a capsule is exposed to microwaves having a frequency of 2.45 GHz.
O: Capsule is smoothly crushed within 5 minutes after exposed to microwaves
Δ: Capsule is only deformed in shape not smoothly crushed when exposed to microwaves
X: Capsule is not deformed in shape or crushed when exposed to microwaves

TABLE 9

| | Classification | | |
|---|---|---|---|
| | Suitability for | | |
| | manufacturing | | Crushability of |
| | capsule | Strength of capsule | microwave |
| Example 1 | ◯ | ◯ | ◯ |
| Example 2 | ◯ | ◯ | ◯ |
| Example 3 | ◯ | ◯ | ◯ |
| Example 4 | ◯ | ◯ | ◯ |
| Example 5 | ◯ | ◯ | ◯ |
| Comparative | ◯ | Δ | X |
| Example 1 | | | |
| Comparative | ◯ | ◯ | Δ |
| Example 2 | | | |
| Comparative | X | — | — |
| Example 3 | | | |

As can be seen in Table 9, capsules including microwave-responsive materials with 20 wt % to 40 wt % were evaluated to be excellent in terms of suitability for manufacturing a capsule, strength, and crushability of microwaves in Example 1 to Example 5. In addition, it can be seen in Comparative Example 1 that a capsule including a microwave-responsive material with 11 wt % is not crushed by microwaves and the strength of a shell is excessively high. In addition, it can be seen in Comparative Example 2 that a capsule including a microwave-responsive material with 15 wt % is not easily crushed by microwaves. It can be seen in Comparative Example 3 that a capsule including a microwave-responsive material with 45 wt % and suitability for manufacturing a capsule is insufficient because a shell of the capsule is excessively soft.

The filter rod 12 may be composed of a plurality of segments. The filter rod 12 may include a first segment 12-1 for cooling an aerosol and a second segment 12-2 for filtering a preset component included in the aerosol. Although FIG. 1 illustrates that the filter rod 12 includes two segments, embodiments are not limited thereto. For example, the filter rod 12 may include a single segment. In addition, the filter rod 12 may further include at least one segment that performs another function.

The filter rod 12 may filter some components included in an aerosol passing through the filter rod 12. The filter rod 12 may include a filter material. For example, the filter rod 12 may be a cellulose acetate filter. The filter rod 12 may be manufactured by adding a plasticizer (for example, triacetin) to cellulose acetate tow.

There is no limitation on a shape of the filter rod 12. For example, the filter rod 12 may be a cylindrical rod or a hollow tubular rod. In addition, the filter rod 12 may be a recessed rod. When the filter rod 12 is composed of multiple segments, at least one of the multiple segments may have a different shape from the other segments.

The filter rod 12 may generate flavor. For example, a flavoring liquid may be sprayed onto the filter rod 12, or a separate fiber coated with a flavoring liquid may be inserted inside the filter rod 12.

The filter rod 12 may include the first segment 12-1 that cools an aerosol. The first segment 12-1 may include a polymer material or a biodegradable polymer material. For example, the first segment 12-1 may include polylactic acid but is not limited thereto. In another example, the first segment 12-1 may include a hollow cellulose acetate tube or a paper tube made of paper.

At least one hole 12-1h may be formed in an outer surface of the first segment 12-1. At least one hole 12-1h may be formed along the circumference of the first segment 12-1 to form at least one row. At least one hole 12-1h may cause external air to be introduced into the first segment 12-1. The external air introduced into the first segment 12-1 may be mixed with a high-temperature aerosol generated by the aerosol generating rod 11.

The aerosol generating article 10 may include a wrapper 14 surrounding one of the aerosol generating rod 11 and the filter rod 12. In addition, the wrapper 14 may surround both the aerosol generating rod 11 and the filter rod 12. The wrapper 14 may be located at the outermost part of the aerosol generating article 10. The wrapper 14 may be a single wrapper but may also be a combination of multiple wrappers.

The aerosol generating article 10 may be wrapped overlappingly by two or more wrappers 14. For example, the aerosol generating rod 11 may be wrapped by a first wrapper 14-1, the first segment 12-1 of the filter rod 12 may be wrapped by a second wrapper 14-2, and the second segment 12-2 of the filter rod 12 may be wrapped by a third wrapper 14-3. In addition, the aerosol generating article 10 may be entirely rewrapped by a fourth wrapper 14-4.

The first wrapper 14-1 may surround the aerosol generating rod 11. The first wrapper 14-1 may be a combination of paper and metal foil, such as aluminum foil. For example, the first wrapper 14-1 may be a stacked sheet in which paper and metal foil are stacked. The first wrapper 14-1 may be a stacked sheet in which the paper is arranged on one side of the metal foil or may be a stacked sheet in which the paper is arranged on both sides of the metal foil.

The paper of the first wrapper 14-1 may include an oil-resistant material. For example, the paper of the first wrapper 14-1 may include polyvinyl alcohol (PVOH) or silicone. The paper of the first wrapper 14-1 may have a surface coated with polyvinyl alcohol or silicone.

The second wrapper 14-2 may surround the first segment 12-1 of the filter rod 12. The second wrapper 14-2 may include a paper roll. The paper roll of the second wrapper 14-2 may be a porous roll or a non-porous roll. At least one perforation 15 may be formed in the second wrapper 14-2. For example, the second wrapper 14-2 may wrap the first segment 12-1 having at least one hole 12-1h formed therein, and at least one perforation 15 formed in the second wrapper 14-2 may be formed at a position corresponding to at least one hole 12-1h formed in the first segment 12-1.

The third wrapper 14-3 may surround the second segment 12-2 of the filter rod 12. The third wrapper 14-3 may include a hard roll having a greater thickness and basis weight than a general paper roll. For example, the hard paper may have a thickness of about 70 μm to about 150 μm, and a weight of about 50 g/m² to about 100 g/m². In addition, the hard paper may include an oil-resistant material. For example, the hard paper may have a surface processed with an oil-resistant material, such as polyvinyl alcohol or silicone.

The fourth wrapper 14-4 may collectively wrap the aerosol generating rod 11 wrapped by the first wrapper 14-1, the first segment 12-1 of the filter rod 12 which is wrapped by the second wrapper 14-2, and the second segment 12-2 of the filter rod 12 which is wrapped by the third wrapper 14-3. The fourth wrapper 14-4 may prevent the outside of the aerosol generating article 10 from being contaminated by an aerosol generated by the aerosol generating article. A liquid material may be generated from the aerosol generating article 10 by a user's puff. For example, the liquid material (for example, moisture or so on) may be generated as an aerosol generated from the aerosol generating article 10 is cooled by external air. As the fourth wrapper 14-4 wraps an outer surface of the aerosol generating article 10, the generated liquid material may be prevented from leaking out of the aerosol generating article 10.

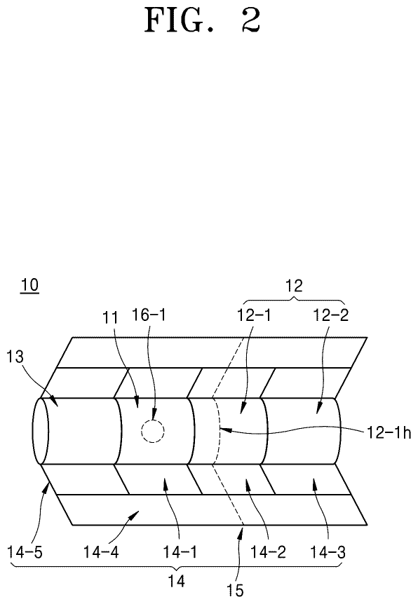

FIG. 2 is a schematic view of an aerosol generating article according to another embodiment.

Referring to FIG. 2, the aerosol generating article 10 may include a front end plug 13, an aerosol generating rod 11, a filter rod 12, and a wrapper 14. The descriptions made above on the aerosol generating rod 11, the filter rod 12, and the wrapper 14 of the aerosol generating article 10 of FIG. 1 may be applied, in the same manner, to the aerosol generating rod 11, the filter rod 12, and the wrapper 14 of the aerosol generating article 10 of FIG. 2.

The front end plug 13 may be arranged upstream from the aerosol generating rod 11. The front end plug 13 may be placed on one side of the aerosol generating rod 11 which is opposite to the filter rod 12. The front end plug 13 may prevent the aerosol generating rod 11 from being separated to the outside. In addition, the front end plug 13 may prevent a liquefied aerosol from the aerosol generating rod 11 from moving to an aerosol generating device during smoking.

The front end plug 13 may include cellulose acetate. For example, the front end plug 13 may be a hollow cellulose acetate tube.

The front end plug 13 may be wrapped by a fifth wrapper 14-5. The fifth wrapper 14-5 may be a combination of paper and metal foil, such as aluminum foil. For example, the fifth wrapper 14-5 may be a stacked sheet in which paper and metal foil are stacked. The fifth wrapper 14-5 may be a stacked sheet in which paper is on one side of metal foil, or a stacked sheet in which paper is on both sides of metal foil.

In addition, the front end plug 13 may be wrapped overlappingly by two or more wrappers 14. For example, the front end plug 13 may be wrapped by the fifth wrapper 14-5, the aerosol generating rod 11 may be wrapped by the first wrapper 14-1, the first segment 12-1 of the filter rod 12 may be wrapped by the second wrapper 14-2, and the second segment 12-2 of the filter rod 12 may be wrapped by the third wrapper 14-3. In addition, the aerosol generating article 10 may be entirely repackaged by the fourth wrapper 14-4.

The front end plug 13 may also generate an aerosol by being heated. The front end plug 13 may include an aerosol generating material. In addition, the front end plug 13 may include other additives, such as a humectant and/or organic acid and may include a flavoring liquid, such as menthol. For example, the aerosol generating material may include at least one of glycerin, propylene glycol, ethylene glycol, dipropylene glycol, diethylene glycol, triethylene glycol, tetraethylene glycol, and oleyl alcohol. The aerosol generating material may include the same material as the first microwave-responsive material. The aerosol generating material may be heated by being exposed to microwaves, thereby generating an aerosol.

The front end plug 13 may include an aerosol generating substrate. An aerosol generating material may be impregnated into the aerosol generating substrate. The aerosol generating substrate may include a crimped sheet, and the aerosol generating material may be included in the front end plug 13 in a state of being impregnated in the crimped sheet. In addition, other additives, such as a flavoring agent, a humectant, and/or organic acid, may be included in the front end plug 13 in a state of being impregnated in the crimped sheet.

The aerosol generating substrate may be arranged inside the front end plug 13 in a wound state. The wound aerosol generating substrate may be wound around an axis extending in the longitudinal direction of the aerosol generating article 10 but is not limited thereto.

The crimped sheet may be a sheet composed of a polymer material. For example, the polymer material may include at least one of paper, cellulose acetate, lyocell, and polylactic acid. For example, the crimped sheet may be a paper sheet that does not generate an off-flavor due to heat, even when the crimped sheet is heated to a high temperature.

The front end plug 13 may have a length of about 7 mm to about 20 mm, and the aerosol generating rod 11 may have a length of about 7 mm to about 20 mm. However, the length of the front end plug 13 and the length of the aerosol generating rod 11 may be appropriately changed.

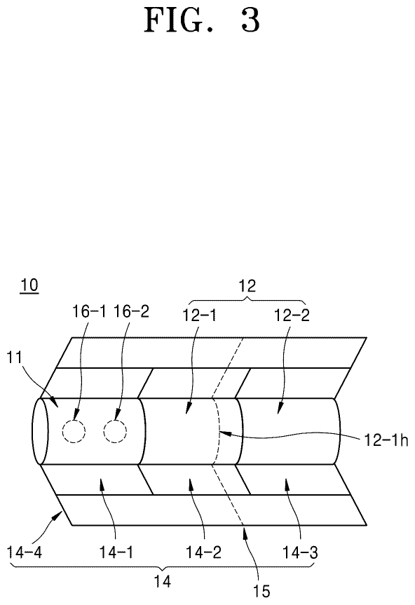

FIG. 3 is a schematic view of an aerosol generating article according to another embodiment.

Referring to FIG. 3, the aerosol generating article 10 may include an aerosol generating rod 11, a filter rod 12, and a wrapper 14. The descriptions made above on the aerosol generating rod 11, the filter rod 12, and the wrapper 14 of the aerosol generating article 10 of FIG. 1 may be applied, in the same manner, to the aerosol generating rod 11, the filter rod 12, and the wrapper 14 of the aerosol generating article 10 of FIG. 3.

The aerosol generating article 10 may include a first capsule 16-1 and a second capsule 16-2. The second capsule 16-2 may have the same shape and size as the first capsule 16-1 but is not limited thereto.

The second capsule 16-2 may include a second core and a second shell surrounding the second core. The second core may include a second material. When the second shell is crushed, the second material included in the second core may be released.

The second capsule 16-2 may be exposed to microwaves and crushed. The second shell may include a second microwave-responsive material to be exposed to microwaves and crushed. The second microwave-responsive material is heated by being exposed to microwaves, and thus, the second shell may be crushed. The second microwave-responsive material may function as a dielectric. Electric charges of the dielectric may vibrate or rotate due to microwave resonance, and the dielectric is heated due to frictional heat generated while the electric charges vibrate or rotate, and thus, the second shell may be heated.

Description made above on the first capsule 16-1 may be applied, in the same manner, to the second capsule 16-2. Also, the second core, the second material, the second shell, and the second microwave-responsive material included in the second capsule 16-2 may respectively include the same materials as the first core, the first material, the first shell, and the first microwave-responsive material included in the first capsule 16-1, or may include different materials.

For example, the second core, the second shell, and the second microwave-responsive material may respectively be the same as the first core, the first shell, and the first microwave-responsive material, while the second material may be different from the first material. In another example, the first capsule 16-1 may have the same components as the second capsule 16-2, except for the first microwave-responsive material and the second microwave-responsive material. In another example, the second core, the second material, the second shell, and the second microwave-responsive material may respectively include the same materials as the first core, the first material, the first shell, and the first microwave-responsive material, while contents of the microwave-responsive materials included in the respective shells may be different from each other.

The first capsule 16-1 may be crushed at a different time from the second capsule 16-2. For example, the first capsule 16-1 may be crushed at the beginning of a heating period, and the second capsule 16-2 may be crushed at the end of the heating period. Here, the “heating period” may mean a time length from the time when a heater assembly of an aerosol generating device to be described below starts heating to the time when the heating ends. In addition, a part corresponding to an initial time of the entire heating period, for example, a time length corresponding to about half of the heating period, may correspond to an “early part of the heating period”, and the other time lengths may correspond to a “latter half of the heating period”.

As the first capsule 16-1 and the second capsule 16-2 are crushed at different points in time, the first material and the second material may be released at different points in time. Because the first material and the second material are released at different points in time, an active material (for example, a flavoring material, nicotine, or so on) may be prevented from being depleted in the latter half of the heating period.

For example, when the first material includes a different flavoring material from the second material, an aerosol having different flavors depending on points in time of crushing of respective capsules may be provided. For example, when the first capsule 16-1 is crushed at the beginning of the heating period and the second capsule 16-2 is crushed at the latter half of the heating period, an aerosol to which flavor of the first material is added may be provided at the beginning of the heating period, and an aerosol to which flavor of the second material is added may be provided at the latter half of the heating period.

The first capsule 16-1 is placed upstream from the second capsule 16-2 and may be crushed earlier than the second capsule 16-2. As the capsule placed upstream is crushed earlier than the capsule placed downstream, flavors added to an aerosol may be prevented from being mixed together.

For example, when the second capsule 16-2 placed downstream is crushed in the beginning of the heating period and the first capsule 16-1 placed upstream is crushed in the latter half of the heating period, the first material released in the latter half of the heating period may pass through the second capsule 16-2 together with an aerosol. Therefore, a problem that the first material is mixed with the second material may occur.

In contrast to this, when the first capsule 16-1 placed upstream is crushed in the beginning of the heating period and the second capsule 16-2 placed downstream is crushed in the latter half of the heating period, the second material released in the latter half of the heating period does not pass through the first capsule 16-1, and accordingly, the problem that the first material is mixed with the second material may be prevented.

The first microwave-responsive material may include a different material from the second microwave-responsive material. For example, the first microwave-responsive material may include glycerin, and the second microwave-responsive material may include propylene glycol. Accordingly, a heating speed of the first microwave-responsive material which is heated by microwaves is different from a heating speed of the second microwave-responsive material which is heated by microwaves, and as a result, the first capsule 16-1 may be crushed at a different time from the second capsule 16-2.

The first shell and the second shell may each include the same material as the microwave-responsive material, but may have different contents from each other. For example, the first microwave-responsive material and the second microwave-responsive material may each include glycerin, the first shell may include glycerin with about 35 wt % to about 40 wt % of the total weight of the first shell, and the second shell may include glycerin with about 20 wt % to about 25 wt % of the total weight of the second shell. Accordingly, the first shell having a large content of microwave-responsive material may react more sensitively to microwaves than the second shell having a small content of microwave-responsive material, and as a result, the first capsule 16-1 may be crushed earlier than the second capsule 16-2.

Although FIG. 1 to FIG. 3 illustrate examples in which the aerosol generating article 10 has a rod shape, the embodiments are not limited thereto. For example, the aerosol generating article may have a sheet shape. The aerosol generating article having a sheet shape may have a circular cross-section when viewed in a direction perpendicular to the longitudinal direction of the aerosol generating article. However, the aerosol generating article is not limited thereto and may have a polygonal shape including a triangle, a rectangle, a square, and a pentagon.

The aerosol generating article having a sheet shape may include a sheet of an aerosol generating substrate and a first capsule arranged on the sheet of the aerosol generating substrate. The aerosol generating article having a sheet shape may have a thickness of about 1 mm to about 20 mm. For example, the aerosol generating article having a sheet shape may have a thickness of about 5 mm to about 15 mm. A diameter of the first capsule included in the aerosol generating article having a sheet shape may be less than a thickness of the aerosol generating article. For example, the aerosol generating article having a sheet shape may have a thickness of about 5 mm to about 10 mm, and a diameter of the first capsule may be about 1 mm to about 3.5 mm.

A sheet of an aerosol generating substrate may be a solid member including an aerosol generating material. The first capsule may be arranged inside a solid member including an aerosol generating material. The solid member including an aerosol generating material may include a tobacco material. For example, the solid member including an aerosol generating material may be an integrated tobacco solid member.

For example, the aerosol generating article having a sheet shape may be manufactured by using a manufacturing method including a step of preparing a tobacco composition including tobacco powder, a binder, and an aerosol generating material, a step of inserting the tobacco composition into a frame having a sheet shape, a step of inserting a first capsule into the tobacco composition inserted in the frame having a sheet shape, and a step of drying the tobacco composition in which the first capsule is inserted. The sheet of the aerosol generating substrate may have a porous structure including a plurality of pores. For example, the sheet of the aerosol generating substrate may include a porous tobacco solid member. For example, the sheet of the aerosol generating substrate may have a specific surface area of 200 m²/g to 1,000 m²/g. Also, the sheet of the aerosol generating substrate may have a specific surface area of 300 m²/g to 800 m²/g.

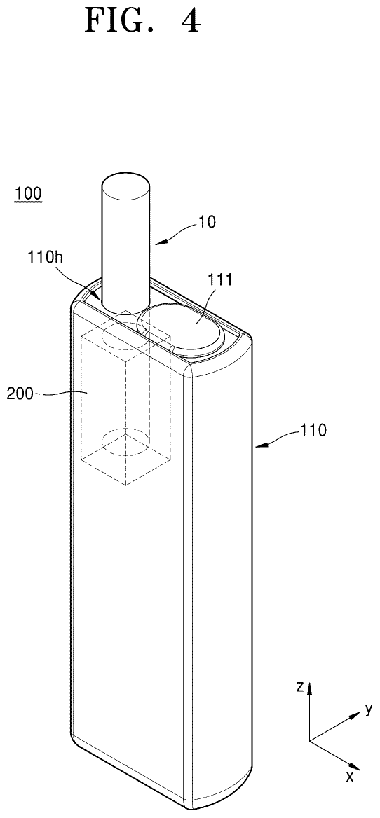

FIG. 4 is a perspective view of an aerosol generating device according to an embodiment.

Referring to FIG. 4, an aerosol generating device 100 according to an embodiment may include a housing 110, which may accommodate an aerosol generating article 10, and a heater assembly 200 for heating the aerosol generating article 10 accommodated in the housing 110.

The housing 110 may form the entire appearance of the aerosol generating device 100, and components of the aerosol generating device 100 may be arranged in an internal space (or a “mounting space”) of the housing 110. For example, a heater assembly 200, a battery, a processor, and/or a sensor may be arranged in the internal space of the housing 110, but the components arranged in the internal space of the housing 110 are not limited thereto.

An insertion hole 110h may be formed in one region of the housing 110, and at least one region of an aerosol generating article 10 may be inserted into the housing 110 through the insertion hole 110h. For example, the insertion hole 110h may be formed in one region of an upper surface (for example, a surface facing the z direction) of the housing 110, but the position of the insertion hole 110h is not limited thereto. In another embodiment, the insertion hole 110h may also be formed in one region of a side surface (for example, a surface facing the x direction) of the housing 110.

The heater assembly 200 is arranged in the interior space of the housing 110 and may heat the aerosol generating article 10 inserted or accommodated in the housing 110 through the insertion hole 110h. For example, the heater assembly 200 may surround at least a part of the aerosol generating article 10 inserted or accommodated in the housing 110 to heat the aerosol generating article 10.

According to an embodiment, the heater assembly 200 may heat the aerosol generating article 10 by using a dielectric heating method. In the disclosure, the “dielectric heating method” means a method of heating a dielectric, which is a heating target, by using resonance of microwaves and/or an electric field (or a magnetic field) of the microwaves. The microwaves are used as an energy source for heating a heating target and generated by high-frequency power, and accordingly, the microwaves may be used interchangeably with microwave power below.

Electric charges or ions of a dielectric included in the aerosol generating article 10 may vibrate or rotate due to microwave resonance inside the heater assembly 200, and heat is generated in the dielectric due to the frictional heat generated while the electric charges or ions vibrate or rotate, and accordingly, the aerosol generating article 10 may be heated.

As the aerosol generating article 10 is heated by the heater assembly 200, an aerosol may be generated from the aerosol generating article 10. In the disclosure, an “aerosol” may mean gas particles generated by mixing air and vapor generated as the aerosol generating article 10 is heated.

The aerosol generated from the aerosol generating article 10 may pass through the aerosol generating article 10 or may be discharged to the outside of the aerosol generating device 100 through an empty space between the aerosol generating article 10 and the insertion hole 110h. A user may smoke by bringing their mouth into contact with a region of the aerosol generating article 10 exposed to the outside of the housing 110 and inhaling the aerosol discharged to the outside of the aerosol generating device 100.

The aerosol generating device 100 according to the embodiment may further include a cover 111 that is movably arranged in the housing 110 to open or close the insertion hole 110h. For example, the cover 111 may be slidably coupled to an upper surface of the housing 110 and may expose the insertion hole 110h to the outside of the aerosol generating device 100 or cover the insertion hole 110h such that the insertion hole 110h is not exposed to the outside of the aerosol generating device 100.

In one example, the cover 111 may expose the insertion hole 110h to the outside of the aerosol generating device 100 at a first position (or an “open position”). When the aerosol generating device 100 is exposed to the outside, the aerosol generating article 10 may be inserted into the housing 110 through the insertion hole 110h.

In another example, the cover 111 may cover the insertion hole 110h at a second position (or a “closed position”), and accordingly, the insertion hole 110h may be prevented from being exposed to the outside of the aerosol generating device 100. In this case, the cover 111 may prevent an external foreign material from being introduced into the heater assembly 200 through the insertion hole 110h when the aerosol generating device 100 is not in use.

An aerosol generating device according to another embodiment includes the heater assembly 200 for heating the aerosol generating article 10 and an aerosol generating material in a liquid or gel state, and may also include a cartridge (or a “vaporizer”) for heating the aerosol generating material. An aerosol generated from the aerosol generating material may move to the aerosol generating article 10 through an airflow passage connecting the cartridge to the aerosol generating article 10, be mixed with the aerosol generated from the aerosol generating article 10, and then pass through the aerosol generating article 10 to be transferred to a user.

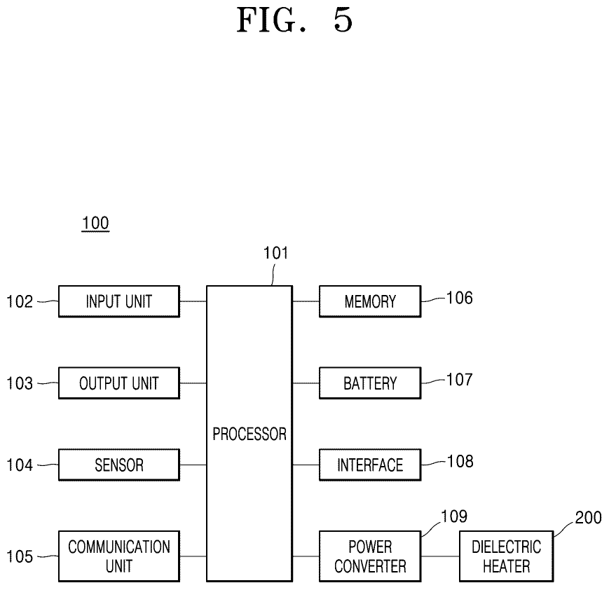

FIG. 5 is an internal block diagram of an aerosol generating device according to an embodiment.

Referring to FIG. 5, an aerosol generating device 100 may include an input unit 102, an output unit 103, a sensor 104, a communication unit 105, a memory 106, a battery 107, an interface 108, a power converter 109, and a dielectric heater 200. However, an internal configuration of the aerosol generating device 100 is not limited to the configuration illustrated in FIG. 5. Depending on designs of the aerosol generating device 100, some of components illustrated in FIG. 5 may be omitted, or new components may be added to the aerosol generating device 100.

The input unit 102 may receive a user input. For example, the input unit 102 may be provided as a single pressure push button. In another example, the input unit 102 may be a touch panel including at least one touch sensor. The input unit 102 may transmit an input signal to the processor 101. The processor 101 may supply power to the dielectric heater 200 based on user input, or control the output unit 103 such that a user notification is output.

The output unit 103 may output information on a state of the aerosol generating device 100. The output unit 103 may output charging and discharging states of the battery 107, a heating state of the dielectric heater 200, an insertion state of the aerosol generating article 10, and error information of the aerosol generating device 100. To this end, the output unit 103 may include a display, a haptic motor, and an audio output unit.

The sensor 104 may detect a state of the aerosol generating device 100 or an ambient state of the aerosol generating device 100 and transmit the detected information to the processor 101. The processor 101 may control the aerosol generating device 100 to perform various functions, such as heating control of the dielectric heater 200, smoking restriction, determining whether the aerosol generating article 10 is inserted, and displaying a notification based on the detected information.

The sensor 104 may include a temperature sensor, a puff sensor, and an insertion detection sensor.

The temperature sensor may detect the temperature inside the dielectric heater 200 in a non-contact manner, or may directly obtain the temperature of a resonator by coming into contact with the dielectric heater 200. According to an embodiment, the temperature sensor may also detect the temperature of the aerosol generating article 10. Also, the temperature sensor may be arranged adjacent to the battery 107 to obtain the temperature of the battery 107. The processor 101 may control the power supplied to the dielectric heater 200 based on temperature information of the temperature sensor.

The puff sensor may detect a user's puff. The puff sensor may detect a user's puff based on at least one of a temperature change, a flow amount change, a power change, and a pressure change. The processor 101 may control the power supplied to the dielectric heater 200 based on puff information of the puff sensor. For example, the processor 101 may count the number of puffs and disconnect the power supplied to the dielectric heater 200 when the number of puffs reaches a preset maximum number of puffs. In another example, the processor 101 may disconnect the power supplied to the dielectric heater 200 when no puff is detected for a preset time or more.

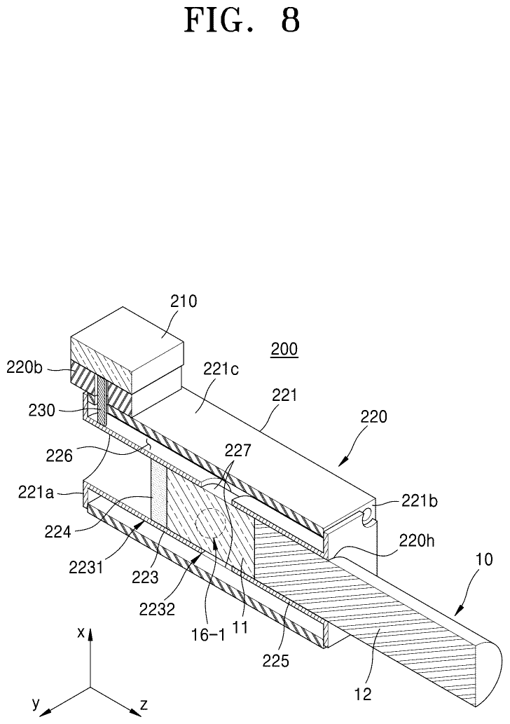

The insertion detection sensor may be arranged inside an accommodation space 220h (see FIG. 8) or adjacent to the accommodation space 220h and detect insertion and removal of the aerosol generating article 10 accommodated in the insertion hole 110h. For example, the insertion detection sensor may include an inductive sensor and/or a capacitance sensor. The processor 101 may supply power to the dielectric heater 200 when the aerosol generating article 10 is inserted into the insertion hole 110h.

According to the embodiment, the sensor 104 may further include a reuse detection sensor, a motion detection sensor, a humidity sensor, a barometric pressure sensor, a magnetic sensor, a cover removal detection sensor, a position sensor (or a global positioning sensor (GPS)), a proximity sensor, and so on. Functions of the respective sensor may be intuitively inferred from names of the respective sensors, and accordingly, detailed descriptions thereof are omitted.

The communication unit 105 may include at least one communication module for communicating with an external electronic device. The processor 101 may control the communication unit 105 such that information on the aerosol generating device 100 is transmitted to an external electronic device. Also, the processor 101 may receive information from the external electronic device through the communication unit 105 and control components included in the aerosol generating device 100. For example, the information transmitted between the communication unit 105 and the external electronic device may include user authentication information, firmware update information, user smoking pattern information, and so on.

The memory 106 is a hardware that stores various types of data processed by the aerosol generating device 100, and may store the data processed by the processor 101 and the data to be processed by the processor 101. For example, the memory 106 may store operation times of the aerosol generating device 100, the greatest number of puffs, the current number of puffs, at least one temperature profile, data on a user's smoking pattern, and so on.

The battery 107 may supply power to the dielectric heater 200 such that the aerosol generating article 10 may be heated. Also, the battery 107 may supply power required for operations of the other components provided in the aerosol generating device 100. The battery 107 may be a rechargeable battery or a detachable and removable battery.

The interface 108 may include a connection terminal that may be physically connected to an external electronic device. The connection terminal may include at least one or a combination of a high-definition multimedia interface (HDMI) connector, a Universal Serial Bus (USB) connector, a secure digital (SD) card connector, or an audio connector (for example, a headphones connector). The interface 108 may transmit and receive information to and from an external electronic device through the connection terminal, or may charge power.

The power converter 109 may convert direct current (DC) power supplied from the battery 107 into alternating current (AC) power. Also, the power converter 109 may provide the AC power to the dielectric heater 200. The power converter 109 may be an inverter including at least one switching element, and the processor 101 may control turning the switching element included in the power converter 109 on or off to convert DC power into AC power. The power converter 109 may be configured by a full bridge or a half bridge.

The dielectric heater 200 may heat the aerosol generating article 10 by using a dielectric heating method. The dielectric heater 200 may correspond to the heater assembly 200 of FIG. 4.

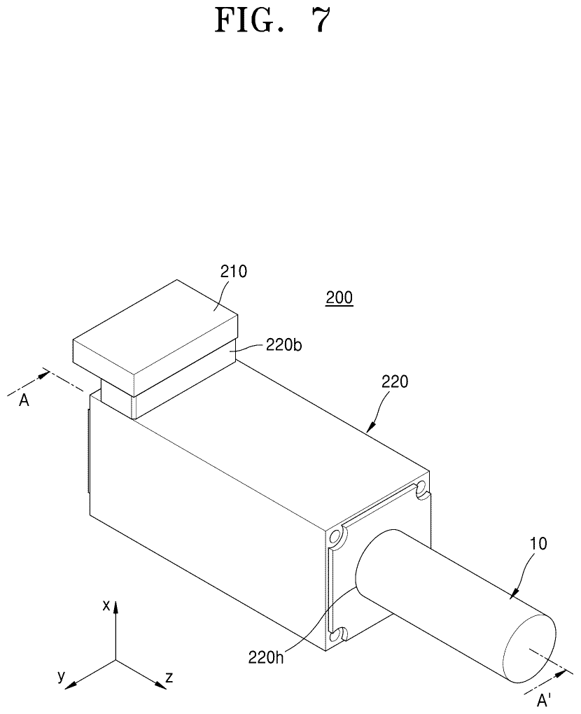

The dielectric heater 200 may heat the aerosol generating article 10 by using microwaves and/or an electric field of the microwaves (hereinafter, referred to as microwaves or microwave power when there is no need for distinction). A heating method of the dielectric heater 200 may be a method of heating a heating target by forming microwaves in a resonance structure, rather than a method of radiating microwaves by using an antenna. The resonance structure is described below with reference to FIG. 7 and below.

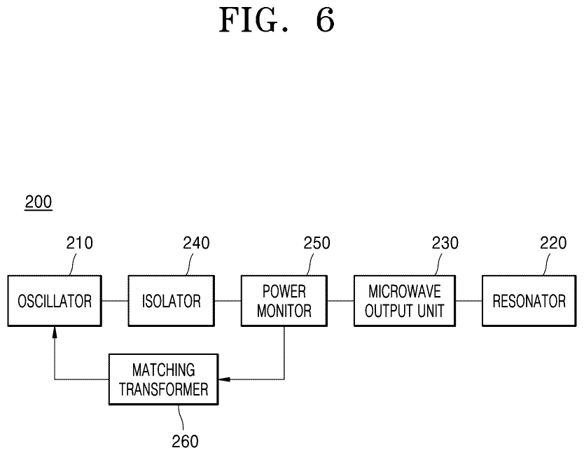

The dielectric heater 200 may output high-frequency microwaves to a resonator 220 (see FIG. 6). The microwaves may be power in an industrial scientific and medical (ISM) equipment band allowed for heating but are not limited thereto. The resonator 220 may be designed by considering wavelengths of the microwaves such that the microwaves may resonate within the resonator 220.

The aerosol generating article 10 may be inserted into the resonator 220, and a dielectric material in the aerosol generating article 10 may be heated by the resonator 220. For example, the aerosol generating article 10 may include a polar material, and molecules in the polar material may be polarized in the resonator 220. The molecules may vibrate or rotate due to a polarization phenomenon, and the aerosol generating article 10 may be heated by frictional heat generated during the vibration or rotation of the molecules. The dielectric heater 200 is described in more detail below with reference to FIG. 6.

The processor 101 may control all operations of the aerosol generating device 100. The processor 101 may be implemented by an array of a plurality of logic gates, or may be implemented by a combination of a general-purpose microprocessor and a memory storing a program that may be executed by the general-purpose microprocessor. Also, the processor 101 may be implemented by another type of hardware.

The processor 101 may control the DC power supplied from the battery 107 to the power converter 109 according to the power demand of the dielectric heater 200, and/or the AC power supplied from the power converter 109 to the dielectric heater 200. In one embodiment, the aerosol generating device 100 may include a converter that boosts or lowers DC power, and the processor 101 may adjust a level of the DC power by controlling the converter. Also, the processor 101 may control the AC power supplied to the dielectric heater 200 by adjusting a switching frequency and duty ratio of a switching element included in the power converter 109.

The processor 101 may control a heating temperature of the aerosol generating article 10 by controlling microwave power of the dielectric heater 200 and a resonance frequency of the dielectric heater 200. Therefore, an oscillator 210, an isolator 240, a power monitor 250, and a matching transformer 260 illustrated in FIG. 6 and described below may also be components of the processor 101.

The processor 101 may control microwave power of the dielectric heater 200 based on temperature profile information stored in the memory 106. That is, the temperature profile may include information on a target temperature of the dielectric heater 200 over time, and the processor 101 may control the microwave power of the dielectric heater 200 over time.

The processor 101 may adjust the frequency of a microwave such that the resonance frequency of the dielectric heater 200 is constant. The processor 101 may track the change in resonance frequency of the dielectric heater 200 in real time according to the heating of a heating target and control the dielectric heater 200 such that the microwave frequency according to the changed resonance frequency is output. That is, the processor 101 may change the microwave frequency in real time regardless of the pre-stored temperature profile.

FIG. 6 is an internal block diagram of the dielectric heater 200 of FIG. 5.

Referring to FIG. 6, the dielectric heater 200 may include the oscillator 210, the isolator 240, the power monitor 250, the matching transformer 260, a microwave output unit 230, and a resonator 220. However, an internal configuration of the dielectric heater 200 is not limited to the configuration illustrated in FIG. 6. Depending on designs of the dielectric heater 200, some of the components illustrated in FIG. 6 may be omitted, or new components may be added to the dielectric heater 200.

The oscillator 210 may receive AC power from the power converter 109 and generate high-frequency microwave power. According to an embodiment, the power converter 109 may be included in the oscillator 210. The microwave power may be selected from among 915 MHZ, 2.45 GHz, and 5.8 GHz frequency bands included in an ISM band.

The oscillator 210 may include a solid-state-based RF generation device and generate microwave power by using the solid-state-based RF generation device. The solid-state-based RF generation device may be implemented by a semiconductor. When the oscillator 210 is implemented by a semiconductor, there is an advantage in that the dielectric heater 200 is reduced in size and increases in lifespan.

The oscillator 210 may output microwave power to the resonator 220. The oscillator 210 may include a power amplifier that increases or decreases the microwave power, and the power amplifier may adjust the microwave power under the control by the processor 101. For example, the power amplifier may decrease or increase an amplitude of a microwave. By adjusting the amplitude of the microwave, the microwave power may be adjusted.

The processor 101 may adjust the microwave power output from the oscillator 210 based on a pre-stored temperature profile. For example, the temperature profile may include target temperature information according to a preheating period and a smoking period, and the oscillator 210 may supply microwave power as first power in the preheating period and supply microwave power as second power that is less than the first power in the smoking period.

The isolator 240 may block the microwave power input from the resonator 220 to the oscillator 210. Most of the microwave power output from the oscillator 210 is absorbed by a heating target, but depending on heating patterns of the heating target, a part of the microwave power may be reflected by the heating target and transmitted again to the oscillator 210. This is because the impedance viewed from the oscillator 210 toward the resonator 220 changes due to the depletion of polar molecules according to the heating of the heating target. The meaning of “impedance viewed from the oscillator 210 toward the resonator 220 changes” may be the same as the meaning of “a resonance frequency of the resonator 220 changes”. When the microwave power reflected from the resonator 220 is input to the oscillator 210, the oscillator 210 may fail, and the expected output performance may not be achieved. The isolator 240 may absorb the microwave power reflected from the resonator 220 by guiding the microwave power in a preset direction without returning the microwave power to the oscillator 210. Due to this, the isolator 240 may include a circulator and a dummy load.

The power monitor 250 may monitor both the microwave power output from the oscillator 210 and the microwave power reflected from the resonator 220. The power monitor 250 may transmit information on the microwave power and the reflected microwave power to the matching transformer 260.

The matching transformer 260 may match the impedance of the resonator 220 viewed from the oscillator 210 to the impedance of the oscillator 210 viewed from the resonator 220 such that the reflected microwave power is reduced. Impedance matching may have the same meaning as matching the frequency of the oscillator 210 to the resonance frequency of the resonator 220. Therefore, the matching transformer 260 may vary the frequency of the oscillator 210 to match the impedance of the matching transformer 260. That is, the matching transformer 260 may adjust the frequency of the microwave power output from the oscillator 210 such that the reflected microwave power is reduced. The impedance matching of the matching transformer 260 may be performed in real time regardless of a temperature profile.

In addition, the oscillator 210, the isolator 240, the power monitor 250, and the matching transformer 260 described above may be separate components from the microwave output unit 230 and resonator 220 described below, and may be implemented as a microwave source in the form of a chip. Also, according to an embodiment, the oscillator 210, the isolator 240, the power monitor 250, and the matching transformer 260 described above may also be implemented as a part of the processor 101.

The microwave output unit 230 may cause microwave power to be input to the resonator 220 and may correspond to a coupler of FIG. 6 and below. The microwave output unit 230 may be implemented in the form of an SMA, SMB, MCX, or MMCX connector. The microwave output unit 230 may connect a chip-shaped microwave source to the resonator 220, and accordingly, the microwave power generated by the microwave source may be transmitted to the resonator 220.

The resonator 220 may heat a heating target by forming microwaves within a resonance structure. The resonator 220 may include an accommodation space in which the aerosol generating article 10 is accommodated, and the aerosol generating article 10 may be exposed to microwaves to be dielectrically heated. For example, the aerosol generating article 10 may include a polar material, and molecules in the polar material may be polarized by the microwaves within the resonator 220. The molecules may vibrate or rotate due to a polarization phenomenon, and the aerosol generating article 10 may be heated by frictional heat generated during the vibration or rotation of the molecules.

The resonator 220 may include at least one internal conductor such that microwaves may resonate, and the microwaves may resonate in the resonator 220 according to an arrangement, a thickness, a length, and so on of the internal conductor.

The resonator 220 may be designed by considering wavelengths of microwaves such that the microwaves may resonate in the resonator 220. In order for microwaves to resonate in the resonator 220, a short end having a closed cross-section and an open end having at least one region of a cross-section opened in an opposite direction to the closed end are required. Also, a length between the short end and the open end has to be set to an integer multiple of a quarter wavelength of a microwave. The resonator 220 according to the disclosure selects a quarter wavelength of a microwave to reduce a size of a device. That is, the length between the short end and the open end of the resonator 220 may be set to a quarter wavelength of a microwave.

The resonator 220 may include a dielectric accommodation space. The dielectric accommodation space 226 is different from the accommodation space of the aerosol generating article 10, and a material that may change all resonance frequencies of the resonator 220 and reduce a size of the resonator 220 is provided in the dielectric accommodation space 226. In one embodiment, a dielectric with a low microwave absorbance may be accommodated in the dielectric accommodation space 226. This is to prevent the phenomenon in which energy that has to be transferred to a heating target is transferred to a dielectric and the dielectric itself is heated. A microwave absorbance may be represented as a loss tangent, which is a ratio of a real part a complex dielectric constant to an imaginary part of the complex dielectric constant. In one embodiment, a dielectric with a loss tangent less than a preset size may be accommodated in the dielectric accommodation space 226, and the preset size may be 1/100. For example, the dielectric may be at least one of quartz, tetrafluoroethylene, and aluminum oxide, or a combination thereof but is not limited thereto.

FIG. 7 is a perspective view of a heater assembly according to an embodiment.

Referring to FIG. 7, a heater assembly 200 according to an embodiment may include an oscillator 210 and a resonator 220. An aerosol generating article 10 illustrated in FIG. 7 may refer to the aerosol generating article 10 illustrated in FIG. 1. FIG. 7 may be an example of the heater assembly 200 and the dielectric heater 200 described above, and redundant descriptions thereof are omitted below.

The oscillator 210 may generate microwaves of a designated frequency band when power is supplied to the oscillator 210. The microwaves generated by the oscillator 210 may be transmitted to the resonator 220 through a coupler (not illustrated).

The resonator 220 may include an accommodation space 220h for accommodating at least one region of the aerosol generating article 10 and may heat the aerosol generating article 10 in a dielectric heating manner by resonating the microwaves generated by the oscillator 210. For example, electric charges of an aerosol generating material included in the aerosol generating article 10 may vibrate or rotate according to the resonance of the microwaves, and the aerosol generating material may be heated by the frictional heat generated when the electric charges vibrate or rotate, and accordingly, the aerosol generating article 10 may be heated.

According to an embodiment, the resonator 220 may be formed of a material with a low microwave absorption rate to prevent the microwave generated by the oscillator 210 from being absorbed by the resonator 220.

Hereinafter, a specific structure of the resonator 220 of the heater assembly 200 is described with reference to FIG. 8.

FIG. 8 is a cross-sectional view of the heater assembly 200 of FIG. 7. FIG. 8 shows a cross-section of the heater assembly 200 of FIG. 7 taken along line A-A′.

Referring to FIG. 8, the heater assembly 200 according to an embodiment may include an oscillator 210, a resonator 220, and a coupler 230. Components of the heater assembly 200 may be the same as or similar to at least one of the components of the heater assembly 200 illustrated in FIG. 7, and redundant descriptions thereof are omitted below.

The oscillator 210 may generate microwaves of a specified frequency band when an AC voltage is applied to the oscillator 210, and the microwaves generated by the oscillator 210 may be transmitted to the resonator 220 through the coupler 230.

According to an embodiment, the oscillator 210 may be fixed to the resonator 220 to prevent the oscillator 210 from being separated from the resonator 220 during use of an aerosol generating device. In one example, the oscillator 210 may be fixed onto the resonator 220 by being supported by a bracket 220b protruding in the x direction in one region of the resonator 220. In another example, the oscillator 210 may also be fixed onto the resonator 220 in a manner of being attached to one region of the resonator 220 without the bracket 220b.

Although FIG. 8 illustrates only an embodiment in which the oscillator 210 is fixed to one region of the resonator 220 facing the x direction, a position of the oscillator 210 is not limited to the illustrated embodiment. In another embodiment, the oscillator 210 may also be fixed to another region of the resonator 220 facing the −z direction.

The resonator 220 may surround at least one region of the aerosol generating article 10 inserted in an aerosol generating device, and the aerosol generating article 10 may be heated by the microwaves generated by the oscillator 210. For example, dielectric materials included in the aerosol generating article 10 may be heated by an electric field generated inside the resonator 220b by microwaves, and the aerosol generating article 10 may be heated by the heat generated in the dielectric (that is, an aerosol generating material).

According to an embodiment, the resonator 220 may include an outer conductor 221, a first inner conductor 223, and a second inner conductor 225.

The outer conductor 221 may form the entire appearance of the resonator 220, and components of the resonator 220 having a hollow interior may be arranged inside the outer conductor 221. The outer conductor 221 may include an accommodation space 220h in which the aerosol generating article 10 may be accommodated, and the aerosol generating article 10 may be inserted into the outer conductor 221 through the accommodation space 220h.

According to an embodiment, the outer conductor 221 may include a first surface 221a, a second surface 221b facing the first surface 221a, and a side surface 221c surrounding a free space between the first surface 221a and the second surface 221b. At least some (for example, the first inner conductor 223 and the second inner conductor 225) of the components of the resonator 220 may be arranged in an internal space of the resonator 220 which is formed by the first surface 221a, the second surface 221b, and the side surface 221c.

The first inner conductor 223 is formed in a hollow cylindrical shape extending in a direction from the first surface 221a of the outer conductor 221 toward an internal space of the outer conductor 221, and when the microwaves generated by the oscillator 210 is transmitted, an electric field may be generated inside the first inner conductor 223. According to an embodiment, the first inner conductor 223 may also be referred to as a “first resonator” that generates an electric field through resonance of microwaves.

According to an embodiment, one region of the first inner conductor 223 may be in contact with the coupler 230 connected to the oscillator 210, and as the microwaves transmitted through the coupler 230 resonate, an electric field may be generated inside the first inner conductor 223. For example, the coupler 230 may pass through the outer conductor 221, one end of the coupler 230 may be in contact with the oscillator 210, and the other end of the coupler 230 may be in contact with one region of the first inner conductor 223, and as microwaves generated by the oscillator 210 are transmitted to the first inner conductor 223 through the coupler 230, an electric field may be generated inside the first inner conductor 223.

The second inner conductor 225 may be formed in a hollow cylindrical shape extending from the second surface 221b of the outer conductor 221 toward an inner space of the outer conductor 221. The second inner conductor 225 may be arranged in the inner space of the outer conductor 221 to be separated from the first inner conductor 223 by a preset distance, and there may be a gap 227 between the first inner conductor 223 and the second inner conductor 225.

Inductive coupling may be made between the second inner conductor 225 and the first inner conductor 223, and accordingly, when an electric field is generated inside the first inner conductor 223, an induced electric field may also be generated inside the second inner conductor 225. In the disclosure, the “inductive coupling” may mean a coupling relationship in which energy may be magnetically transferred by mutual inductance between two conductors.

For example, when the microwaves generated by the oscillator 210 are transmitted to the first internal conductor 223, an electric field may be generated inside the first internal conductor 223 by resonance, and an induced electric field may be generated inside a second internal conductor 225 inductively coupled to the first internal conductor 223. According to an embodiment, the second internal conductor 225 may also be referred to as a “second resonator” that generates an electric field through resonance of microwaves.

According to an embodiment, the resonator 220 may include a short end having a closed cross-section to have a quarter length (λ/4) of a wavelength λ of a microwave, and an open end that is placed on an opposite side of the short end and that has a cross-section of which at least one region is opened.

In one example, the resonator 220 may include a closing portion 224 placed inside the first inner conductor 223 and closing a cross-section of the first inner conductor 223, and as a cross-section of the first inner conductor 223 is closed by the closing portion 224, a short end may be formed in a first region 2231 of the first inner conductor 223 where the closing portion 224 is arranged. The closing portion 224 is not in a second region 2232 spaced apart from the first region 2231 of the first inner conductor 223, and accordingly, a cross-section of the second region 2232 may be opened, and as a result, an open end may be formed in the second region 2232 of the first inner conductor 223. That is, when viewed from an xz plane, the first internal conductor 223 may be formed in a “⊏” (Korean alphabet) shape on the whole and include a short end and an open end, and according to a structure of the first internal conductor 223 described above, the first internal conductor 223 may operate as a resonator having a quarter wavelength of a microwave.

In another example, the accommodation space 220h may be formed in one region of the second internal conductor 225 which faces the short end, and accordingly, a cross-section of the second internal conductor 225 may be opened, and as a result, when viewing the resonator 220 on the whole, a short end may be formed in the first region 2231 of the first internal conductor 223, and an open end may be formed in one end of the second internal conductor 225 which faces the short end, and accordingly, resonance of a quarter wavelength may be generated inside the resonator 220.

According to the resonance structure of the resonator 220 described above, an electric field may not be transferred to an external region of the resonator 220 where there is no conductor, such as the first internal conductor 223 or the second internal conductor 225. Therefore, the heater assembly 200 may prevent an electric field from leaking to the outside of the heater assembly 200 without a separate shielding member for shielding the electric field.

The aerosol generating article 10 inserted into the internal space of the outer conductor 221 through the accommodation space 220h may be surrounded by the first internal conductor 223 and the second internal conductor 225 to be heated by a dielectric heating method. For example, a part of the aerosol generating article 10 inserted into the inner space of the outer conductor 221 may be arranged inside the first inner conductor 223 and the second inner conductor 225, and another part thereof may be arranged outside the first inner conductor 223 and the second inner conductor 225. When a dielectric included in the aerosol generating article 10 is heated by an electric field generated inside and outside the first inner conductor 223 and/or the second inner conductor 225, the aerosol generating article 10 may be heated.

According to an embodiment, when the aerosol generating article 10 is inserted into the resonator 220 through the accommodation space 220h, the aerosol generating rod 11 of the aerosol generating article 10 may be at a position corresponding to the gap 227 between the first internal conductor 223 and the second internal conductor 225.

A resonance peak may be generated in an end portion of the first internal conductor 223 operating as the first resonator and an end portion of the second internal conductor 225 operating as the second resonator, and accordingly, a stronger electric field may be generated in the end portions compared to other regions, and as a result, the strongest electric field may be generated in the gap 227 between the first internal conductor 223 and the second internal conductor 225 among the internal regions of the resonator 220. In the heater assembly 200 according to an embodiment, the aerosol generating rod 11 including a dielectric that is heated by an electric field is arranged at a position corresponding to the gap 227 where the electric field is strongest, and accordingly, heating efficiency (or “dielectric heating efficiency”) of the heater assembly 200 may be increased.

According to an embodiment, the resonator 220 may further include the dielectric accommodation space 226 for accommodating a dielectric. The dielectric accommodation space 226 may be formed in a space between the outer conductor 221, the first inner conductor 223, and the second inner conductor 225, and a dielectric with a low microwave absorbance may be accommodated in the dielectric accommodation space 226. For example, the dielectric may be formed of at least one of quartz, tetrafluoroethylene, and aluminum oxide, or a combination thereof but is not limited thereto.

The heater assembly 200 according to an embodiment may generate an electric field similar to the electric field of the resonator 220 that does not include a dielectric by arranging a dielectric inside the dielectric accommodation space 226 and may reduce the entire size of the resonator 220. That is, in the heater assembly 200 according to an embodiment, a size of the resonator 220 may be reduced through the dielectric arranged inside the dielectric accommodation space 226, and a mounting space of the resonator 220 in an aerosol generating device may be reduced, and as a result, the aerosol generating device may be miniaturized.

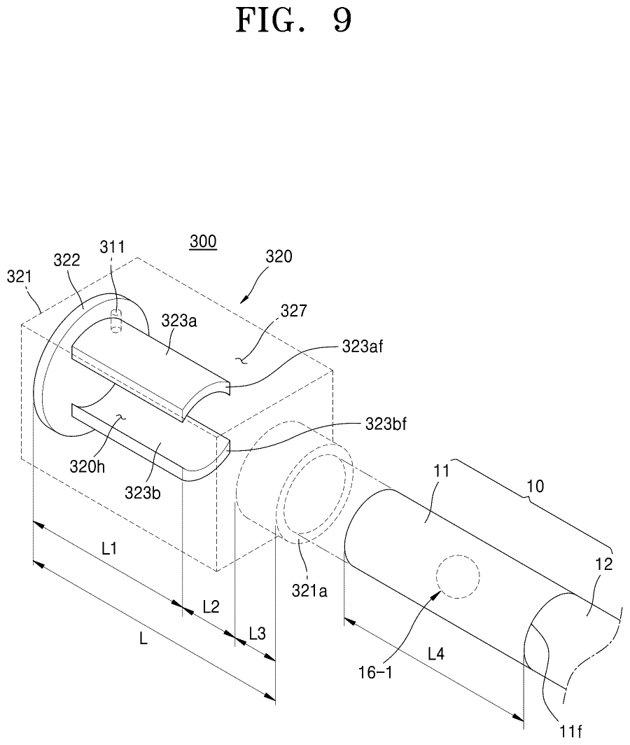

FIG. 9 is a perspective view schematically illustrating a heater assembly according to another embodiment.

A heater assembly 300 according to the embodiment illustrated in FIG. 9 may include a resonator 320 that generates microwave resonance, and a coupler 311 that supplies microwaves to the resonator 320. An aerosol generating article 10 illustrated in FIG. 9 may refer to the aerosol generating article 10 illustrated in FIG. 1.

The resonator 320 may include a case 321, a plurality of plates 323a and 323b, and a connector 322 that connects the plurality of plates 323a and 323b to the case 321.

The coupler 311 may supply microwaves to at least one of the plurality of plates 323a and 323b to generate microwave resonance in the resonator 320.

The resonator 320 may surround at least one region of the aerosol generating article 10 inserted into the aerosol generating device 100. The coupler 311 may supply the microwaves generated by an oscillator (not illustrated) to the resonator 320. When microwaves are supplied to the resonator 320, microwave resonance occurs in the resonator 320, and accordingly, the resonator 320 may heat the aerosol generating article 10. For example, dielectrics included in the aerosol generating article 10 may be heated by an electric field generated inside the resonator 220 by microwaves, and the aerosol generating article 10 may be heated by the heat generated by the dielectrics.

The case 321 of the resonator 320 functions as an “outer conductor”. The case 321 has a hollow shape in which the inside of the case 321 is empty, and accordingly, components of the resonator 320 may be arranged inside the case 321.

The case 321 may include an accommodation space 320h in which the aerosol generating article 10 may be accommodated, and an opening 321a into which the aerosol generating article 10 may be inserted. The opening 321a may be connected to the accommodation space 320h. The opening 321a is opened toward the outside of the case 321, and accordingly, the accommodation space 320h may be connected to the outside through the opening 321a. Therefore, the aerosol generating article 10 may be inserted into the accommodation space 320h of the case 321 through the opening 321a of the case 321.

Although FIG. 9 illustrates that the case 321 has a square cross-sectional shape, the shape of the case 321 may be changed to various shapes. For example, the case 321 may have one of various cross-sectional shapes, such as a rectangle, an ellipse, or a circle. The case 321 may extend in one direction.

The plurality of plates 323a and 323b that may function as an “internal conductor” of the resonator 320 may be arranged inside the case 321.

The plurality of plates 323a and 323b may be arranged to be separated from each other in a circumferential direction of the aerosol generating article 10 accommodated in the accommodation space 320h. The plurality of plates 323a and 323b may include a first plate 323a surrounding one region of the aerosol generating article 10 and a second plate 323b surrounding another region of the aerosol generating article 10.

The plurality of plates 323a and 323b may be connected to the case 321 through the connector 322. Also, one end of the first plate 323a may be connected to one end of the second plate 323b by the connector 322. Therefore, closed ends may be formed at ends of the plurality of plates 323a and 323b by the connector 322.

An end 323af of the first plate 323a and an end 323bf of the second plate 323b may be separated from each other and be opened. Because the ends 323af and 323bf are separated from each other, open ends may be formed at the other ends of the plurality of plates 323a and 323b.

A resonator assembly may be completed by connecting the plurality of plates 323a and 323b to the connector 322. A shape of a cross-section taken along a longitudinal direction of the resonator assembly may include a “horseshoe-shape”.

The plurality of plates 323a and 323b may extend toward a longitudinal direction of the aerosol generating article 10. At least a part of each of the plurality of plates 323a and 323b may be curved to protrude outwardly from the center of the longitudinal direction of the aerosol generating article 10.

For example, when the aerosol generating article 10 has a cylindrical shape, the plurality of plates 323a and 323b may be curved in a circumferential direction along an outer circumferential surface of the aerosol generating article 10. A radius of curvature of a cross-section of each of the plurality of plates 323a and 323b may be equal to a radius of curvature of the aerosol generating article 10. The radius of curvature of the cross-section of each of the plurality of plates 323a and 323b may be variously modified. For example, the radius of curvature of the cross-section of each of the plurality of plates 323a and 323b may be greater or less than the radius of curvature of the aerosol generating article 10.

According to the structure in which the plurality of plates 323a and 323b are curved in a circumferential direction along an outer circumferential surface of the aerosol generating article 10, a more uniform electric field is formed in the resonator 320, and accordingly, the heater assembly 300 may uniformly heat the aerosol generating article 10.

The open ends of the ends 323af and 323bf of the plurality of plates 323a and 323b may face the opening 321a of the case 321. The opening 321a of the case 321 may be separated from the ends 323af an 323bf of the plurality of plates 323a and 323b to be far away therefrom.

The open ends of the ends 323af and 323bf of the plurality of plates 323a and 323b may be aligned with respect to the opening 321a of the case 321. Therefore, when the aerosol generating article 10 is inserted into the accommodation space 320h through the opening 321a of the case 321, a part of the aerosol generating article 10 which is placed in the accommodation space 320h may be surrounded by the plurality of plates 323a and 323b.

The plurality of plates 323a and 323b are arranged on an opposite side of the center of a longitudinal direction of the aerosol generating article 10. The embodiments are not limited to the number of the plurality of plates 323a and 323b, and the number of the plurality of plates 323a and 323b may be, for example, three, four, or more.

The plurality of plates 323a and 323b may be arranged to be symmetrical to a central axis of a longitudinal direction of the aerosol generating article 10, that is, a direction in which the aerosol generating article 10 extends.

At least one of the plurality of plates 323a and 323b may be in contact with the coupler 311 connected to an oscillator (not illustrated). Specifically, at least a part of the first plate 323a may be in contact with the coupler 311. As the microwaves transmitted to the first plate 323a through the coupler 311 resonate in the plurality of plates 323a and 323b, an electric field may be generated in the plurality of plates 323a and 323b and the connector 322.

The coupler 311 may pass through the case 321, and accordingly, one end of the coupler 311 may be in contact with an oscillator (not illustrated), and the other end of the coupler 311 may be in contact with one region of the first plate 323a. As the microwaves generated by the oscillator (not illustrated) are transmitted to the plurality of plates 323a and 323b and the connector 322 through the coupler 311, an electric field may be generated inside an assembly of the plurality of plates 323a and 323b and the connector 322.

Also, according to a structure of the resonator 320 of the heater assembly 300, a triple resonance mode may be formed in the resonator 320. Resonance of a transverse electric & magnetic (TEM) mode of microwaves is formed between the plurality of plates 323a and 323b. Also, resonances of the TEM mode different from the resonance formed between the plurality of plates 323a and 323b may be formed respectively between the first plate 323a and an upper plate of the case 321 and between the second plate 323b and a lower plate of the case 321.

As triple resonance is generated in the resonator 320 of the heater assembly 300, the aerosol generating article 10 may be heated more effectively and uniformly.

The resonator 320 according to the embodiment described above may include a short end of which cross-section is closed to have a quarter length ë/4 of a wavelength ë of a microwave, and an open end of which cross-section is in an opposite direction to the short end and at least one region is opened.

In FIG. 9, a region of one end of the resonator 320 corresponding to a left region forms a short end closed by a structure in which one end of each of the plurality of plates 323a and 323b and the connector 322 are connected to the case 321. In FIG. 9, a region of the other end of the resonator 320 corresponding to a right region forms an open end by opening the opening 321a of the case 321 to the outside. With the structure of the resonator 320, the resonator 320 may operate as a resonator having a quarter wavelength of a microwave.

According to a resonance structure of the resonator 320 described above, an electric field may not be transferred to an external region of the resonator 320. Therefore, the heater assembly 300 may prevent an electric field from leaking to the outside of the heater assembly 300 even without a separate shielding member for shielding the electric field.

The aerosol generating article 10 inserted into the accommodation space 320h of the case 321 may be surrounded by the first plate 323a and the second plate 323b to be heated by a dielectric heating method. For example, a part including a medium (for example, the aerosol generating rod 11) of the aerosol generating article 10 inserted into the accommodation space 320h of the case 321 may be arranged in a space between the first plate 323a and the second plate 323b. The aerosol generating article 10 may be heated when a dielectric included in the aerosol generating article 10 is heated by an electric field generated in a space between the first plate 323a and the second plate 323b.

When the aerosol generating article 10 is inserted into the resonator 320 through the accommodation space 320h, the aerosol generating rod 11 of the aerosol generating article 10 may be placed between the plurality of plates 323a and 323b.

A length L4 of the aerosol generating rod 11 may be greater than a lengths L1 of each of the plurality of plates 323a and 323b. Therefore, a front end 11f of the aerosol generating rod 11 in contact with the filter rod 12 may be placed at a position that protrudes more than the other end 323af of the first plate 323a and the other end 323bf of the second plate 323b in a direction toward the opening 321a of the case 321.

A resonance peak may be formed at the other end of each of the plurality of plates 323a and 323b that operate as resonators, and accordingly, a stronger electric field may be generated compared to other regions. When the aerosol generating article 10 is inserted into the heater assembly 300, the aerosol generating rod 11 including a dielectric that may generate heat by an electric field may be arranged to correspond to a region where an electric field is strongest, and accordingly, heating efficiency (or “dielectric heating efficiency”) of the heater assembly 300 may be increased.

Also, in the aerosol generating article 10 illustrated in FIG. 2, the sum of lengths of the front end plug 13 and the aerosol generating rod 11 may be greater than the length L1 of each of the plurality of plates 323a and 323b. That is, a length from an upstream end of the aerosol generating article 10 to a downstream end of the aerosol generating rod 11 may be greater than the length L1 of each of the plurality of plates 323a and 323b.

Referring to FIG. 9, the length L1 of each of the plurality of plates 323a and 323b may be less than a length L1+L2 of an internal space of the case 321. Therefore, the other ends of the plurality of plates 323a and 323b may be placed inside the case 321 rather than the opening 321a. That is, the other ends of the plurality of plates 323a and 323b may be separated from a rear end of the opening 321a by a distance L2.

A length from the rear end of the opening 321a where the opening 321a is connected to the case 321 to a front end of the opening 321a where the opening 321a is opened may be L3. A total length of the case 321 in the longitudinal direction of the case 321 may be L. An entire length L of the case 321 may be determined by the sum of the length L1 of each of the plurality of plates 323a and 323b, the length L2 which is a separated distance between the rear end of the opening 321a and the plurality of plates 323a and 323b, and the length L3 of a protrusion of the opening 321a from the case 321.

In order to prevent leakage of microwaves, the front end of the opening 321a in which the opening 321a is opened is placed at a position in which the opening 321a protrudes from the case 321 by the length of L3. As the opening 321a of the case 321 protrudes from the case 321, the opening 321a may function to prevent microwaves inside the case 321 of the resonator 320 from leaking to the outside of the case 321.

The resonator 320 may further include a dielectric accommodation space 327 for accommodating a dielectric. The dielectric accommodation space 327 may be formed in a free space between the case 321 and the plurality of plates 323a and 323b. A dielectric with a low microwave absorbance may be accommodated in the dielectric accommodation space 327.

By providing a dielectric inside the dielectric accommodation space 327, the entire size of the resonator 320 of the heater assembly 300 may be reduced, and an electric field at the same level as the electric field generated by the resonator that does not include a dielectric may be generated. That is, a mounting space of the resonator 320 in an aerosol generating device may be reduced by reducing a size of the resonator 320 through a dielectric arranged inside the dielectric accommodation space 327, and as a result, the aerosol generating device may be miniaturized.

An aerosol generating system according to an embodiment may include the aerosol generating article 10 and the aerosol generating device 100. For example, the aerosol generating system according to an embodiment may include the aerosol generating article 10 of FIGS. 1 to 3 described above and the aerosol generating device 100 illustrated in FIGS. 4 to 9.

In the general aerosol generating system of the related art, a heating element surrounds an external portion of an aerosol generating article or is inserted into the aerosol generating article to heat the aerosol generating article. In this case, a region of the aerosol generating article which is close to a heating element may be heated to a relatively high temperature, and a region of the aerosol generating article which is relatively far from the heating element may be heated to a relatively low temperature.

For example, in an aerosol generating system in which a heating element surrounds the outside of an aerosol generating article, only an external region of the aerosol generating article may be intensively heated, and an internal region of the aerosol generating article may not be sufficiently heated. In another example, in an aerosol generating system in which a heating element is inserted into an aerosol generating article, only an internal region of an aerosol generating article may be intensively heated, and an external region of the aerosol generating article may not be sufficiently heated.

As an aerosol generating article is heated unevenly, an active ingredient (for example, nicotine and/or an aerosol generating material) in a region of the aerosol generating article which is heated to a relatively low temperature may not be completely transferred and may remain inside the aerosol generating article.

Also, as an aerosol generating article is heated unevenly, the amount of active ingredients of an aerosol transferred to a user may not be uniform in the entire heating period, and a taste of smoke may not be constant.

Also, in the general aerosol generating system of the related art, the temperature of an aerosol generating article increases as heat energy is conducted from a high-temperature heating element, and accordingly, a certain amount of preheating time may be required to heat the aerosol generating article. Also, an aerosol, which is generated at the beginning of a heating period in which the temperature of an aerosol generating article is not sufficiently increased, may not sufficiently include nicotine or an aerosol generating material.

Here, the “heating period” may mean a time length from a point in time when a heater assembly of an aerosol generating device starts heating to a point in time when the heating ends. Also, a time period corresponding to an initial part of the entire heating period, for example, a time period corresponding to about half of the heating period, may correspond to the “beginning of the heating period”, and the other time period may correspond to the “latter half of the heating period”.

In the aerosol generating system according to an embodiment, an aerosol generating material, which is a dielectric dispersed in a medium (for example, the aerosol generating rod 11 of FIGS. 1 and 3, or the front end plug 13 and the aerosol generating rod 11 of FIG. 2) of the aerosol generating article 10 is heated by a dielectric heating method, and thus, a problem of uneven heating of the aerosol generating article 10 may be resolved.

For example, in an aerosol generating system according to an embodiment, the aerosol generating article 10 may be uniformly heated, and thus, the amount of active ingredients (for example, nicotine and/or an aerosol generating material) of an aerosol transferred to a user may be constant throughout the entire heating period, and a taste of smoke may be provided with constant quality. Also, the entire region of the aerosol generating article 10 is uniformly heated, and thus, most of the nicotine and/or aerosol generating material included in the aerosol generating article 10 may be transferred.

Also, a process of conducting heat energy from a heating element to the aerosol generating article 10 may be omitted, and thus, the time required for preheating may be reduced. Also, an aerosol generated at the beginning of a heating period of the aerosol generating article 10 included in an aerosol generating device may include a sufficient amount of nicotine and aerosol generating material.

The entire region of an aerosol generating article according to the embodiments is uniformly heated, and thus, most of the active ingredients included in the aerosol generating article may be transferred. Also, because an aerosol generating article may be uniformly heated, the amount of active ingredients of an aerosol transferred to a user is uniform throughout the entire heating period, and a taste of smoke may be provided with constant quality.

also, a capsule of an aerosol generating article according to the embodiments may be easily crushed without the intervention of a user.

An aerosol generating system according to the embodiments may reduce the time required for preheating, and an aerosol generated at the beginning of the heating period may also include a sufficient amount of active ingredients.

Effects of the embodiments are not limited to the effects described above, and effects that are not described may be clearly understood by those skilled in the art from the present specification and the attached drawings.

Any of the embodiments or other embodiments of the disclosure described above are not mutually exclusive or distinct. Any of the embodiments or other embodiments of the disclosure described above may be combined or used together in respective configurations or functions thereof.

For example, a configuration A described in a certain embodiment and/or a drawing may be combined with a configuration B described in another embodiment and/or drawing. That is, even when coupling of configurations is not directly described, the coupling may be made except a case in which the coupling is described to be impossible.

The above detailed description should not be construed as limiting in all aspects and should be considered as illustrative. The scope of the disclosure should be determined by a reasonable interpretation of the appended claims, and all changes within the equivalent scope of the disclosure are included in the scope of the disclosure.

What is claimed is:

1. An aerosol generating article comprising:
an aerosol generating material that is heated by being exposed to microwaves; and
a first capsule that is crushed by being exposed to the microwaves,
wherein the first capsule incudes a first core including a first material and a first shell surrounding the first core, and
the first shell includes a first microwave-responsive material.

2. The aerosol generating article of claim 1, wherein the first material includes at least one selected from a group including a flavoring material, nicotine, caffeine, and cannabinoid.

3. The aerosol generating article of claim 1, wherein each of the microwaves has a frequency of 2.4 GHz to 2.5 GHz.

4. The aerosol generating article of claim 1, wherein the first shell includes the first microwave-responsive material with 20 wt % to 40 wt % of a total weight of the first shell.

5. The aerosol generating article of claim 1, wherein the first microwave-responsive material includes at least one selected from a group including glycerin, propylene glycol, ethylene glycol, dipropylene glycol, diethylene glycol, triethylene glycol, tetraethylene glycol, and oleyl alcohol.

6. The aerosol generating article of claim 1, wherein the aerosol generating article includes an aerosol generating rod including the aerosol generating material and the first capsule, and a filter rod arranged downstream from the aerosol generating rod.

7. The aerosol generating article of claim 6, wherein the aerosol generating article further includes a front end plug arranged upstream from the aerosol generating rod.

8. The aerosol generating article of claim 7, wherein the front end plug includes an aerosol generating substrate in which an aerosol generating material is impregnated.

9. The aerosol generating article of claim 1, wherein
the aerosol generating article further includes a second capsule that is crushed by being exposed to the microwaves,
the second capsule includes a second core including a second material and a second shell surrounding the second core, and
the second shell includes a second microwave-responsive material.

10. The aerosol generating article of claim 9, wherein the first capsule and the second capsule are crushed at different point in time by being exposed to the microwaves.

11. The aerosol generating article of claim 9, wherein the first capsule is arranged upstream from the second capsule and is crushed earlier than the second capsule by being exposed to the microwaves.

12. An aerosol generating system comprising:
the aerosol generating article according to claim 1; and
an aerosol generating device configured to accommodate the aerosol generating article,
wherein the aerosol generating device includes a heater assembly configured to generate microwaves for heating the aerosol generating article.

13. The aerosol generating system of claim 12, wherein
the heater assembly includes a resonator configured to generate the microwaves,
the resonator includes a plurality of plates separated from each other in a circumferential direction of the aerosol generating article, and
the microwaves are resonated by the plurality of plates.

14. The aerosol generating system of claim 13, wherein
first ends of the plurality of plates are connected to a connector, and
second ends of the plurality of plates are separated from each other and are opened.

15. The aerosol generating system of claim 13, wherein
the plurality of plates extend in a longitudinal direction of the aerosol generating article, and
at least a part of each of the plurality of plates is curved to protrude outward from the center of a longitudinal direction of the aerosol generating article.
